(19) United States
(12) Patent Application Publication
(10) Pub. No.: US 2005/0225927 A1
(43) Pub. Date: Oct. 13, 2005

(54) Processes for the production of niobium oxides with controlled tantalum content and capacitors made therefrom

(76) Inventors: Solon Yasuhiko Tagusagawa, Sao Paulo (BR); Antonio Telhado Pereira, Araxa (BR); Alberto Akikazu Ono, Araxa (BR)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 10/818,606

(22) Filed: Apr. 6, 2004

(51) Int. Cl. C01G 33/00; H01G 2/00

(52) U.S. Cl. 361/271; 423/594.17

(57) ABSTRACT

The present invention relates to niobium oxides having a controlled tantalum content and processes for producing such niobium oxides. The tantalum content can be homogenous or heterogeneous and can be obtained using various process, including co-precipitation, impregnation, deposition, and mixing processes. Niobium pentoxide having a controlled tantalum content can further be reduced to niobium monoxide with controlled tantalum content using a single step reduction process, or can first be reduced to niobium-dioxide with controlled tantalum content using a two step process. The niobium monoxide with controlled tantalum content produced according to such processes can exhibit a high surface area and an appropriate morphology, and can be used to make capacitors with a high capacitance and a low leakage current.

### BACKGROUND OF THE INVENTION

1. Field of the Invention

The present invention relates a process for preparing niobium pentoxide with a controlled tantalum content using co-precipitation, impregnation, deposition, or mixing methodologies. Each of these methodologies can be used for obtaining a niobium pentoxide with controlled tantalum content, which can have adequate chemical composition, morphology, porosity, particle size, and surface area for further processing to a niobium monoxide product with suitable physical and chemical properties for capacitor applications.

2. Description of the Related Art

Production of pure niobium pentoxide is well known in the art, and is described in several handbooks, including “Columbium and Tantalum,” edited by Frank T. Sisco and Edward Epremien, 1963, John Wiley & Sons, Inc.; “Niobium, Proceedings of the International Symposium,” edited by Harry Stuart, 1981, The Metallurgical Society of AIME; and “Extractive Metallurgy of Refractory Metals”, edited by H. Y. Sohn, O. N. Carlson, J. T. Smith, 1980, The Metallurgical Society of AIME. However, it is not known in the art to produce a niobium pentoxide with a controlled tantalum content.

Such a niobium pentoxide with a controlled tantalum content is a desirable feed material for production of niobium monoxide for use as a anode for capacitors which have improved capacitance and low leakage current. The miniaturization of cell phones, lap top computers, and other electronic devices, requires capacitors of smaller size, higher capacitance, and lower leakage current.

Partial reduction of pure niobium pentoxide to niobium monoxide with hydrogen gas, such as by using refractory or reactive metals, and/or hydrides of refractory or reactive metals, as an oxygen getter material is known in the art. Such methods are described in, for example, U.S. Pat. Nos. 6,322,912, 6,373,685, 6,391,275, 6,416,730, 6,462,934 B2, and 6,576,099 B2; in the Handbook of Preparative Inorganic Chemistry by G. Brauer and A. Simon, 1978, Vol. 2, 3rd Edition, pg. 1317 (“Niobium Monoxide”); in a paper published in Journal of Mining and Metallurgical Institute of Japan, 1966, Vol. 82, No. 942, pg. 855 (“Preparation and Chlorination of NbO₂, NbO and NbC”); in a paper published in Transactions ISIJ (Iron and Steel Institute of Japan), 1971, Vol. 11, pg. 102 (“Electrochemical Measurement of the Standard Free Energies of Formation of Niobium Oxides”); and in a doctoral thesis submitted by E. R. Pollard, Jr. at the Massachusetts Institute of Technology, in 1968 (“Electronic Properties of Niobium Monoxide”).

In these patents and papers, various methods are described for partially reducing niobium pentoxide to an oxygen depleted niobium oxide, which could be a niobium monoxide. More specifically, for example, a niobium monoxide can be obtained by holding the mixture of niobium pentoxide and niobium metal powders at 1000° C. for several hours in a hydrogen atmosphere and cooling quickly to room temperature in the same reducing atmosphere. In another example, niobium monoxide can also be produced by heat-treating the niobium oxide in the presence of a oxygen getter material, and in an atmosphere which permits the transfer of oxygen atoms from the niobium oxide to the getter material, for a sufficient time and temperature to form the niobium monoxide.

The usage of niobium monoxide as an anode material for a capacitor is also described in the above-mentioned patents. However, no reference describes using a niobium monoxide with controlled tantalum content as the anode material for a capacitor, wherein the niobium monoxide with controlled tantalum content is obtained by reduction of a niobium pentoxide having a controlled tantalum content, which can be obtained, according to the invention, by co-precipitation, impregnation, deposition or mixing.

### SUMMARY OF THE INVENTION

According to the invention, certain processes related to the production of niobium monoxide having a controlled tantalum content are provided. The niobium monoxide with controlled tantalum content produced according to such process can have desirable properties for use in forming capacitors. The processes more particularly include processes for producing niobium pentoxide having a controlled tantalum content and processes for reducing such niobium pentoxide with controlled tantalum content to niobium monoxide with controlled tantalum content.

The processes further include methods for reducing the niobium pentoxide with controlled tantalum content to niobium monoxide with controlled tantalum content using either a single step reducing process, or a two step reducing process wherein the niobium pentoxide with controlled tantalum content is reduced to niobium dioxide with controlled tantalum content in the first step and then to niobium monoxide with controlled tantalum content in the second step.

The processes for producing the niobium pentoxide having a controlled tantalum content also include different morphologies, or methods, such as, co-precipitation, impregnation, deposition, and mixing.

A co-precipitation process according to the invention can comprise the addition of a quantitative amount of soluble tantalum salt into a solution of a niobium salt before the co-precipitation of both elements. The co-precipitated compound can then be calcined to obtain a homogenous niobium pentoxide with controlled tantalum content.

An impregnation process according to the invention can comprise wetting niobium pentoxide, or hydrate niobium pentoxide, with a tantalum saturated solution, and thereafter calcining the product to obtain a heterogeneous niobium pentoxide with controlled tantalum content.

A deposition process according to the invention can comprise covering niobium pentoxide, or hydrate niobium pentoxide, with a tantalum compound and thereafter calcining the product to obtain a heterogeneous niobium pentoxide with controlled tantalum content. The tantalum compound can be precipitated from a saturated tantalum solution.

A mixing process according to the invention can comprise simply mixing niobium pentoxide or hydrate niobium pentoxide with tantalum oxide or hydrate tantalum oxide. The niobium pentoxide with controlled tantalum content can be obtained by calcination of the mixture.

According to the invention, the niobium monoxide with controlled tantalum content can be produced from the niobium pentoxide with controlled tantalum content by either a single step process, or a two step process. The single step process can comprise holding a mixture of the niobium pentoxide with controlled tantalum content and a oxygen getter material in a reducing atmosphere at a sufficient temperature, and for a sufficient time to obtain niobium monoxide with controlled tantalum content. The reducing atmosphere may also be provided at a certain pressure.

Alternatively, the two step process can be employed wherein the first step can comprise the reduction of the niobium pentoxide with controlled tantalum content to niobium dioxide with controlled tantalum content. This reduction can be carried out employing a gaseous reducing agent, at a sufficient temperature and for a sufficient time to produce the niobium dioxide with controlled tantalum content. The reducing atmosphere may also be provided at a certain pressure. The second step can comprise the reduction of the niobium dioxide with controlled tantalum content obtained in the first step to niobium, monoxide with controlled tantalum content by employing an oxygen getter material, as a reductant, in a reducing atmosphere which permits the transfer of the oxygen atoms from the niobium dioxide to the getter material, and under adequate conditions of time and temperature to form the niobium monoxide with controlled tantalum content. The reducing atmosphere may also be provided at a certain pressure.

Further in accordance with the invention, a niobium monoxide powder with controlled tantalum content produced according to the foregoing processes can be used for the manufacture of capacitors having a high capacitance and a low leakage current.

### BRIEF DESCRIPTION OF THE DRAWING FIGURES

FIG. 1 is a Scanning Electron Microscopy (“SEM”) photograph of niobium dioxide agglomerate containing tantalum (magnification 20,000×).

FIG. 2 is an SEM photograph of niobium monoxide agglomerate containing tantalum (magnification 100×).

FIG. 3 is an SEM photograph of niobium monoxide agglomerate containing tantalum (magnification 10,000×).

### DETAILED DESCRIPTION OF THE INVENTION

According to the invention, certain processes for the production of niobium monoxide having a controlled tantalum content are provided, including processes for producing niobium pentoxide having a controlled tantalum content and processes for reducing the niobium pentoxide with controlled tantalum content to niobium monoxide powder with controlled tantalum content. The processes for producing the niobium pentoxide having a controlled tantalum content can employ, for example, co-precipitation, impregnation, deposition, and mixing. Single or two step processes can be employed for reducing the niobium pentoxide with controlled tantalum content to niobium monoxide powder with controlled tantalum content.

According to the invention, the co-precipitation process for the production of niobium pentoxide having a controlled tantalum content can generally comprise adding a soluble tantalum salt to a solution of niobium salt, co-precipitating both the niobium and the tantalum, and then calcining the co-precipitated product to obtain the niobium pentoxide with controlled tantalum content. The co-precipitated compound can also be dried prior to calcination.

In the first step of the co-precipitation process, a quantitative amount of soluble tantalum salt is added to the solution of niobium salt. The quantitative amount is generally the amount necessary to obtain the calculated amount of controlled tantalum content in the niobium pentoxide. To prepare the solutions, precursors of niobium and tantalum are first dissolved in water, or another suitable medium as would be known to one of ordinary skill in the art, to form a homogeneous solution. These precursor compounds can be, for example, but not limited to, alkaline niobates and tantalates, alkaline fluorniobates and fluortantalates, alkaline oxi-fluorniobates and oxi-fluortantalates, niobium and tantalum hydrous oxide complex (and like oxalates, tartarates, ammonium oxalates, etc.), di-ol complexes, inorganic acid complexes, amine complexes, tropolone chelates, alkoxides, and the like. The solution can be subjected to pH adjustment or evaporation to force those compounds to precipitate. During this co-precipitation, the precursors may be hydrolyzed into hydroxide forms or oxides. The solid mass can then be collected and dried gradually. The dry mass obtained can be ground to powder form, after which further calcination can be undertaken to convert the compounds or hydroxides into oxides.

The temperature for drying the solid mass can be from about 100° C. to about 180° C., and preferably can be from about 100° C. to about 120° C. For calcination, the temperature range can be from about 300° C. to about 600° C., and preferably can be from about 400° C. to about 500° C.

According to the invention, additional process steps can be added to the co-precipitation process. These added process steps can include adding another soluble salt with the soluble tantalum salt and the niobium salt; and then co-precipitating all of the elements. The additional soluble salt can be a soluble salt of at least one of vanadium, zirconium, titanium, hafnium, tungsten, nitrogen, phosphorous, and boron. The amount of soluble salt added can be from about 20 ppm to about 20 weight percent, and preferably from about 100 ppm to about 5 weight percent.

According to the invention, the impregnation process for the production of niobium pentoxide having a controlled tantalum content can generally comprise wetting niobium pentoxide with a tantalum saturated solution and then calcining the niobium pentoxide wetted/impregnated, with the tantalum saturated solution to obtain the niobium pentoxide with controlled tantalum content. The wetted/impregnated niobium can also be dried prior to calcining. The niobium pentoxide could also be hydrate niobium pentoxide. The niobium pentoxide, or hydrate niobium pentoxide, can be coated or impregnated by an incipient wetting of a saturated solution of a suitable tantalum precursor. This wetting can be followed by drying and calcination to yield a niobium pentoxide impregnated with tantalum oxide. The volume of the impregnation solution is controlled to be equal to the pore volume of the niobium pentoxide or hydrate niobium pentoxide. Any tantalum soluble salt can be used as the tantalum precursor. The impregnation solution can be added slowly to the niobium pentoxide or hydrate niobium pentoxide, which can also be constantly mixed to ensure the total absorption of the solution into the pore structure. The moisturized powder can then be dried to remove the solvent from the pores, and can thereafter be calcined to decompose the tantalum precursor. The resulting material is a niobium pentoxide with controlled tantalum content.

The temperature for drying can be from about 100° C. to about 180° C., and preferably can be from about 100° C. to about 120° C. For calcination, the temperature range can be from about 300° C. to about 600° C., and preferably can be from about 400° C. to about 500° C.

According to the invention, additional process steps can be added to the impregnation process. These added process steps can include wetting the niobium pentoxide with a tantalum saturated solution and a saturated solution of an additional element, which can be at least one of vanadium, zirconium, titanium, hafnium, tungsten, nitrogen, phosphorous, and boron. The thus wetted niobium pentoxide is then calcined as in the base process. The amount of the additional element added can be from about 20 ppm to about 20 weight percent, and preferably from about 100 ppm to about 5 weight percent.

According to the invention, the deposition process for the production of niobium pentoxide having a controlled tantalum content can generally comprise covering the niobium pentoxide with a tantalum compound and then calcining the elements to obtain the niobium pentoxide with controlled tantalum content. The elements can also be dried prior to calcination. The tantalum compound can be obtained via precipitation from a saturated solution of a suitable tantalum precursor. The niobium pentoxide can also be hydrate niobium pentoxide. The deposition of the tantalum compound can be achieved either by the simple removal of the solvent through heating, or by the co-precipitation of the tantalum precursor through hydroxide ion generation, for instance, from a hot urea solution. In the first instance, an aqueous solution of soluble tantalum salt can be used to prepare slurry with niobium pentoxide. The water can then be removed by heating the slurry up to the water boiling point, which causes the gradual saturation of the solution leading to the deposition, or co-precipitation, of the tantalum precursor onto the niobium pentoxide surface. In the second instance, urea can be added in the aqueous solution of tantalum salt used to prepare the slurry with niobium pentoxide. Upon controlled heating, the urea decomposes, releasing ammonia and generating hydroxide ions, which hydrolyzes the tantalum precursor causing precipitation of tantalum hydroxide onto the niobium pentoxide surface.

In either instance, the resulting powder material can be dried and calcined to yield the niobium pentoxide with controlled tantalum content. The temperature for drying can be from about 100° C. to about 180° C., and can preferably be from about 100° C. to about 120° C. For calcination, the temperature can be from about 300° C. to about 600° C., and can preferably be from about 400° C. to about 500° C.

According to the invention, additional process steps can be added to the deposition process. These added process steps can include covering the niobium pentoxide with a tantalum compound and an additional compound, and then calcining said niobium pentoxide covered with both compounds. The additional compound can be formed from at least one of vanadium, zirconium, titanium, hafnium, tungsten, nitrogen, phosphorous, and boron. The amount of the additional compound added can be from about 20 ppm to about 20 weight percent, and preferably from about 100 ppm to about 5 weight percent.

According to the invention, the mixing process for the production of niobium pentoxide having a controlled tantalum content can generally comprise mixing niobium pentoxide with tantalum oxide and then calcining the mixture to obtain said niobium pentoxide with controlled tantalum content. The niobium pentoxide can be physically mixed with the tantalum oxide. The niobium pentoxide can also be hydrate niobium pentoxide, and the tantalum oxide can also be hydrate tantalum oxide. In the mixing process, finely ground niobium pentoxide, or hydroxide, can be, for example, mechanically mixed with finely ground tantalum oxide, hydroxide, or other tantalum compound. The mixed powders are then calcined from about 300° C. to about 600° C., and can preferably be from about 400° C. to about 500° C. Where hydrate niobium pentoxide and/or hydrate tantalum oxide are used, the mixture can be dried prior to calcining. The drying temperature can be from about 100° C. to about 180° C., and can preferably be from about 100° C. to about 120° C.

According to the invention, additional process steps can be added to the mixing process. These added process steps can include mixing an additional element in with the niobium pentoxide and tantalum oxide. The added element can be at least one of vanadium, zirconium, titanium, hafnium, tungsten, nitrogen, phosphorous, and boron. The amount of the additional element added to the mixture can be from about 20 ppm to about 20 weight percent, and preferably from about 100 ppm to about 5 weight percent.

In general, a niobium pentoxide with a controlled tantalum content obtained using any of the previously described processes employing co-precipitation, impregnation, deposition, or mixing, can have high purity, high specific surface area, and a porosity and morphology desirable for further reduction to niobium monoxide with a controlled tantalum content. In particular, the niobium pentoxide with a controlled tantalum content obtained using any of the aforesaid processes can exhibit characteristics including a specific surface area from about 1.0 to about 45.0 m²/g, and preferably from about 1.8 to about 20.0 m²/g, a sponge-type morphology, a micro-porous structure with a porosity of about 51 percent, or greater, and a tantalum content of from about 20 ppm to about 50 weight percent, and preferably from about 500 ppm to about 10 weight percent.

According the invention, further processes can be employed to reduce the aforesaid niobium pentoxide with controlled tantalum content to niobium monoxide with controlled tantalum content. In a first such embodiment, a single step process can be employed to reduce the niobium pentoxide with controlled tantalum content to niobium monoxide with controlled tantalum content. In this single step process, the niobium pentoxide with controlled tantalum content and a oxygen getter material, which behaves as a reductant, are held in a reducing atmosphere at a sufficient temperature and for a sufficient time to produce a niobium monoxide with a controlled tantalum content. A certain pressure of the reducing atmosphere may also be provided.

The oxygen getter material can be selected from the group consisting of refractory or reactive metals or alloys thereof, and hydrides of refractory or reactive metals or alloys thereof This group can include, for example, titanium, zirconium, vanadium, magnesium, calcium, lithium, aluminum, silicon, and manganese; alloys of titanium, zirconium, vanadium, magnesium, calcium, lithium, aluminum, silicon and manganese; hydrides of titanium, zirconium, vanadium, magnesium, calcium, and lithium; and hydrides of alloys of titanium, zirconium, vanadium, magnesium, calcium and lithium. In one preferred embodiment, the oxygen getter material can be niobium, tantalum, alloys of niobium or tantalum, hydrides of niobium or tantalum, or hydrides of alloys of niobium or tantalum.

The process conditions of the additional, single step reducing process can include carrying out the reaction at a temperature of from about 800° C. to about 1700° C., and for a time period of from about 15 minutes to about 24 hours. In one preferred embodiment, the temperature can be from about 1200° C. to about 1600° C., and the time period can be from about 3 hours to about 12 hours. The product can thereafter be cooled, quickly in a preferred embodiment, in the same atmosphere.

The reducing atmosphere can be, or contain, hydrogen, carbon monoxide, or hydrazine. Alternatively, the reducing atmosphere can contain hydrogen and one or more inert gases, such as, for example, argon, helium, and nitrogen. In one preferred embodiment, the reducing atmosphere can be nitrogen mixed with hydrogen in a manner to enable nitrogen doping of the niobium monoxide with controlled tantalum content.

According to a further embodiment of the invention, the subsequent reduction of the niobium pentoxide with controlled tantalum content can be carried out in a two step process. In this two step process, the first step can comprise the reduction of the niobium pentoxide with controlled tantalum content to niobium dioxide with controlled tantalum content. This first step can be carried out in a first reducing atmosphere at a first temperature, and for first time sufficient to produce the niobium dioxide with controlled tantalum content. The first reducing atmosphere can also be held at a first pressure. The first reducing atmosphere can be, or contain hydrogen, and/or other reducing gases. The second step can comprise the reduction of the niobium dioxide with controlled tantalum content to niobium monoxide with a controlled tantalum content using an oxygen getter material, as a reductant, in a second reducing atmosphere which permits the transfer of the oxygen atoms from the niobium dioxide to the getter material, for a second time period, and at a second adequate temperature to produce the niobium monoxide with controlled tantalum content. The second reducing atmosphere can also be provided at a second pressure.

By using two separate reducing steps, it is possible to control the driving force of the niobium oxide reduction reactions by controlling the potential of the reducing agent in each step, thereby allowing greater control of the process. The use of a raw material in the form of powder, with adequate size and morphology, which, in the first step, can consist basically of niobium pentoxide with controlled tantalum content, and in the second step, niobium dioxide with controlled tantalum content and a refractory metal, or a reactive metal, and/or their hydrides thereof, of high purity, enables the formation of niobium monoxide having a controlled tantalum content with a controlled morphology, porosity, specific surface area, and adequate particle size distribution without the formation of agglomerates of undesirable size.

The reducing agent in the first step can be hydrogen gas, or any other gas or gaseous mixture with adequate reducing potential, such as, for example, carbon monoxide or hydrazine. In the second step, the reducing agent, also referred to as the oxygen getter, or simply the “getter material,” can be a refractory or reactive metal, or metal alloy, and/or a hydride of a refractory or reactive metal or metal alloy. For example, such getter material can include, but not limited to, tantalum, niobium, titanium, zirconium, vanadium, magnesium, calcium, lithium, aluminum, silicon, manganese, and alloys or hydrides of the same.

The niobium pentoxide with controlled tantalum content used in the first reduction step can have any shape or size. Examples of the types of powder that can be used, but not limited to, can include sponge-like, flaked, rod-like, angular, nodular types, and/or a mixture or variations thereof. In a preferred embodiment, the niobium pentoxide with controlled tantalum content can be in the form of a powder with adequate porosity, morphology, and particle size distribution that more effectively leads to an adequate niobium dioxide with controlled tantalum content.

The first step can take place in a first reducing atmosphere of hydrogen gas, or a combination of hydrogen gas with other inert gases in various ratios, such as, but not limited to, argon, helium, and nitrogen. The first reducing atmosphere could also be generally any other gas or gaseous mixture having an adequate reducing potential, such as, for example, carbon monoxide or hydrazine. The first pressure of the gas during the first step of the process may be varied from about 50 Torr to about 2000 Torr, and, in a preferred embodiment, from about 200 Torr to about 1200 Torr.

The temperature and time period of the first step should be adequate for the reduction of the niobium pentoxide with controlled tantalum content to niobium dioxide with controlled tantalum content. The reaction can typically be conducted at temperatures between about 500° C. and about 1500° C., and in a preferred embodiment, between about 700° C. and about 1100° C. The reaction time period can vary from about 1 hour to about 24 hours, and, in a preferred embodiment, can be from about 8 hours to about 18 hours. After the end of the reaction, the product of the reaction can be cooled in the process atmosphere until it reaches room temperature.

The niobium dioxide with controlled tantalum content can have a controlled porosity and specific surface area. This control can be achieved by the proper selection of the niobium pentoxide and by controlling process variables, including, for example, the time, temperature, and pressure of the reaction.

The first step can be conducted in, for example, muffle-type furnaces, retort-type furnaces, moving-hearth furnaces, continuous conveyor belt hearth furnaces, or other type of equipment capable of achieving the required temperatures and of maintaining the reducing atmosphere required for the process.

The niobium dioxide with controlled tantalum content obtained by this process can be physically characterized as having a specific surface area from about 0.4 m²/g to about 30.0 m²/g, and, in a preferred embodiment, from about 0.8 m²/g to about 9.0 m²/g. The niobium dioxide with controlled tantalum content can also exhibit a micro-porous structure with a porosity of about 51 percent or greater, and can also have only a low residual content of niobium pentoxide.

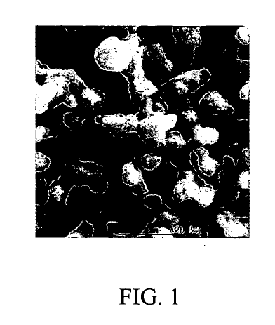

A typical morphology of the niobium dioxide with controlled tantalum content is shown in the SEM photograph in FIG. 1.

In the second reducing step, the niobium dioxide with controlled tantalum content obtained from the first reducing step can be mixed with an oxygen getter material, which can be any material capable of reducing the niobium dioxide to niobium monoxide. In a preferred embodiment, the oxygen getter material can be a refractory or reactive metal, such as, but not limited to, tantalum, niobium, titanium, zirconium, vanadium, magnesium, calcium, lithium, aluminum, silicon, manganese, metal alloys thereof, and/or hydrides thereof. In a further preferred embodiment, the oxygen getter material comprises niobium and/or tantalum, or hydrides thereof. Where the oxygen getter material contains niobium, the getter can be any material containing metallic niobium capable of removing or reducing the oxygen present in the niobium dioxide with controlled tantalum content. Therefore, where niobium is used, the oxygen getter material can comprise an alloy or a material containing a mixture of niobium with other components. In a preferred embodiment, the getter niobium can be predominantly, or entirely, comprised of metallic niobium. Although the purity of this niobium may not be critical, a high purity metallic niobium can be preferable to avoid the introduction of other impurities during the process.

The oxygen getter material may generally have any shape or size. In a preferred embodiment, the oxygen getter material is in the form of powder, in order to have sufficient surface area to function adequately as an oxygen getter. In this case, the oxygen getter material may comprise a powder with angular, flaked, rod-like, nodular, or sponge-like shape, and/or a mixture or variation of these shapes. In a preferred embodiment, the oxygen getter material can be niobium hydride and/or metallic niobium in the form of granules that can be easily separated from the produced niobium monoxide with controlled tantalum content powder by sieving.

A sufficient amount of oxygen getter material should be present to reduce the niobium dioxide with controlled tantalum content to niobium monoxide. Preferably, the amount of oxygen getter material present in the reaction with the niobium dioxide with controlled tantalum content can be from about 1 to 6 times the stoichiometric quantity necessary for fully reducing the niobium dioxide to niobium monoxide.

The second reducing step can be performed in furnaces or reactors commonly used for processing of niobium and/or tantalum, for example, electric vacuum furnaces. The reaction of the niobium dioxide with controlled tantalum content with the getter material can be conducted for a second time period, at a second temperature, and at a second pressure sufficient to allow the reduction of niobium dioxide to niobium monoxide to occur. The temperature and the time of the process can be dependent on several factors, such as, for example, the amount, the morphology, and the particle-size distribution of the niobium dioxide and of the loaded oxygen getter material, as well as the manner in which these materials were mixed. The temperature of the process can be between about 1000° C. and about 1700° C., and, in a preferred embodiment, between about 1200° C. and about 1600° C. The duration of the process can be for a period of time between about 15 minutes and about 18 hours, and, in a preferred embodiment, from about 3 to about 12 hours.

The second step can also be conducted in a second reducing atmosphere that allows the transfer of oxygen atoms from the niobium dioxide with controlled tantalum content to the oxygen getter material. The second reducing atmosphere can contain hydrogen gas, and, in one preferred embodiment, the atmosphere can be predominantly, or entirely, hydrogen gas. However, other gases could be present in addition to the hydrogen, such as, for example, nitrogen, argon and helium, or mixture of thereof, provided that these gases do not significantly lower the reducing potential of the hydrogen. The pressure of the gas during the second step can be from about 100 Torr to about 2000 Torr, and in a preferred embodiment, from about 500 Torr to about 1500 Torr.

In either of the single or two step reducing processes described above, an additional element can be reacted along with the niobium pentoxide and tantalum in the first reducing step. In particular, at least one of vanadium, zirconium, titanium, hafnium, tungsten, nitrogen, phosphorous, and boron can be additionally reacted with the niobium pentoxide and the tantalum in the first reducing step. The additional element, or elements, described above can be added in an amount of about 20 ppm to about 20 weight percent. In a preferred embodiment, the amount can be from about 100 ppm to about 5 weight percent. The result can be that the added element, or elements, form a composite oxide with niobium.

According to the previously described process, a niobium monoxide with controlled tantalum content can be produced, including in powder form, having desirable characteristic for use in manufacturing capacitors. The niobium monoxide with controlled tantalum content produced according to the various processes described herein can be formed having a residual niobium dioxide content of about 5 weight percent, or less, and/or a residual niobium metal content of 5 weight percent, or less. Moreover, The niobium monoxide with controlled tantalum content can be formed having a micro-porous structure with a porosity of about 51 percent, or greater.

A niobium dioxide with controlled tantalum content, as produced in the first reducing step of the two step reduction process, can also have a residual content of niobium pentoxide with controlled tantalum content. Additionally, the niobium monoxide with controlled tantalum content produced in the second reducing step can be substantially pure, such that x-ray diffraction techniques would detect substantially no residual amounts of either niobium dioxide or metallic niobium. The niobium monoxide with controlled tantalum content produced in the second step of the two step reducing process can also typically exhibit an atomic ratio of niobium to oxygen of between about 1:0.6 and about 1:1.5, and, in a preferred embodiment, will exhibit an atomic ratio of niobium to oxygen between about 1:0.7 and about 1:1.1.

The niobium monoxide with controlled tantalum content produced by a two step process as described above can also have a sponge-like morphology, with primary particles of about 1 micron or less, and also binding “necks” between particles having an adequate diameter. Such niobium monoxide with controlled tantalum content can have a convenient porosity that results in high levels of capacitance when used in the manufacture of capacitor anodes. In general, the niobium monoxide with controlled tantalum content according to the present invention can have a specific surface area from about 0.4 m²/g to about 20.0 m²/g, and, in a preferred embodiment, from about 0.8 m²/g to about 6.0 m²/g.

The niobium monoxide with controlled tantalum content, produced via either the additional one or two step reduction process described above, can have a tantalum content in the range of about 20 ppm to about 50 weight percent, and, in a preferred embodiment, in the range of about 500 ppm to about 10 weight percent.

As described previously, the first reducing step of either the single or two step reducing process described above can include reacting at least one of vanadium, zirconium, titanium, hafnium, tungsten, nitrogen, phosphorous, and boron with the niobium pentoxide, in addition to the tantalum. The result of this is that the additional element can form a composite oxide with niobium.

In regard specifically to the use of the co-precipitation process to obtain the niobium pentoxide with controlled tantalum content, a niobium monoxide composition having the characteristics just described can be obtained by controlling the amount of tantalum compound in the solution before its co-precipitation, as will be apparent in the description of the Examples provided hereinafter.

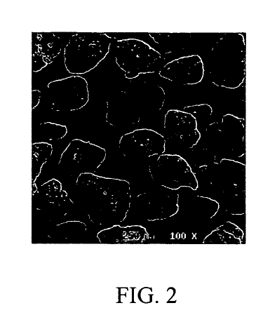

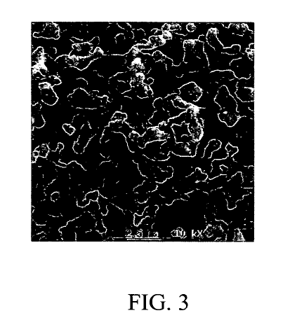

A typical morphology of niobium monoxide with controlled tantalum content is shown in the SEM photographs in FIGS. 2 and 3.

The niobium monoxide with controlled tantalum content produced in the second reducing step can also having a morphology similar to the niobium dioxide with controlled tantalum content. Thus, by controlling the morphology, the porosity, and the particle distribution of the niobium dioxide with controlled tantalum content, it can be possible to obtain niobium monoxide with controlled tantalum content with adequate characteristics for the manufacture of capacitors.

The niobium monoxide with controlled tantalum content according to the present invention can also be characterized by electrical properties of capacitor anodes manufactured therefrom. Capacitor anodes were manufactured by pressing powders of the niobium monoxide with controlled tantalum content to form the anodes, sintering the anodes at appropriate temperatures, and then anodizing the anodes to produce electrolytic capacitor anodes. The electrical properties of these anodes were then measured, as described in more detail below.

The anodes produced by pressing powders of niobium monoxide with controlled tantalum content had a mass of about 100 mg. The anodes tested were sintered in vacuum at about 5.0×10⁻⁵ Torr, and at a temperature of 1450° C. for 10 minutes. The anodizing process was carried out in a 0.1% (by mass) H₃PO₄ solution and the anodizing voltage used was 30 Volts (V). After anodizing, the anodes had a capacitance of from about 50,000 CV/g to about 300,000 CV/g. In a preferred embodiment, the capacitance can be from about 65,000 CV/g to about 160,000 CV/g. The anodes further had a leakage current of about 1.0 nA/CV, or less.

The capacitance after anodizing was measured using an Agilent 4284A LCR bridge, the electrolyte used was 18% (by mass) H₂SO₄ solution, 2.5V to 10V Bias, and the frequency used was 120 Hertz (Hz). The leakage current measurement was conducted in 0.1% (by mass) H₃PO₄ solution, the voltage used corresponded to 70% of the anodizing voltage, that is, 21V, and the current was monitored until 180 seconds after application of the voltage.

### EXAMPLES

The following examples provide further details of the processes and methods according to the invention.

### Example 1

1,000 grams of ammonium niobium oxalate and 0.75 gram of potassium tantalate were dissolved in water, until a homogeneous solution was obtained. This solution was precipitated, and a hydrous niobate and tantalate was obtained. The potassium was eliminated by leaching the precipitates with acid solution several times, followed by several washing with de-ionized water. The precipitates were dried, and calcined to eliminate water and other volatile compounds. The product was characterized and the following results were obtained:
X-Ray Diffraction: Nb₂O₅
Specific surface area, BET analysis method: 10.1 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 700° C. The load was kept at this temperature for 18 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.5 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 10 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.4 m²/g
Tantalum content: 1,530 ppm

The electrical properties were measured, according to the procedure mentioned before. The results were the following:
Capacitance: 110,200 CV/g
Current Leakage: 0.3 nA/CV

The chemical analysis (ppm) of the sample is the following:

C = 41
B < 3
Ca = 11
Cr = 7
Fe < 5
H₂ = 49
Mg = 6
Mn = 5
N₂ = 70
Ni < 10
Ta = 1,530
Zr < 2

### Example 2

1,000 grams of ammonium niobium oxalate were dissolved in a solution containing tantalum oxalate (0.5 gram), until a homogeneous solution was obtained. This solution was precipitated, and a hydrate niobium and tantalum oxide was obtained. The precipitates were washed with de-ionized water several times. The precipitates were dried, and calcined to eliminate water and other volatile compounds. The product was characterized and the following results were obtained:
X-Ray Diffraction: Nb₂O₅
Specific surface area, BET analysis method: 10.5 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 700° C. The load was kept at this temperature for 12 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.8 m²/g
Porosity: 81 percent

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1550° C. and kept at that level for 12 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.0 m²/g
Tantalum content: 1,545 ppm
Porosity: 80 per cent

The electrical properties were measured, according to the procedure mentioned before. The results were the following:
Capacitance: 123,200 CV/g
Current Leakage: 0.1 nA/CV

The chemical analysis (ppm) of the sample is the following:

C = 37
B < 3
Ca = 35
Cr = 5
Fe = 12
H₂ = 112
Mg = 8
Mn = 7
N₂ = 10
Ni < 10
Ta = 1,545
Zr < 2

### Example 3

400 grams of niobium pentachloride and 0.5 gram of tantalum pentachloride were dissolved in alcohol, until a homogeneous solution was obtained. This solution was precipitated by evaporation of the solvent. The precipitates were calcined in air to eliminate volatile compounds. The product was characterized and the following results were obtained:
X-Ray Diffraction: Nb₂O₅
Specific surface area, BET analysis method: 25.5 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 700° C. The load was kept at this temperature for 9 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂

Specific surface area, BET analysis method: 7.1 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 10 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 3.2 m²/g
Tantalum content: 1,550 ppm

The electrical properties were measured, according to the procedure mentioned before. The results were the following:
Capacitance: 195,400 CV/g
Current Leakage: 0.2 nA/CV

The chemical analysis (ppm) of the sample is the following:

C < 30
B < 3
Ca = 6
Cr < 4
Fe < 5
H₂ = 243
Mg = 4
Mn = 5
N₂ < 10
Ni < 10
Ta = 1,550
Zr < 2

### Example 4

1,000 grams of ammonium niobium oxalate were dissolved in a solution containing tantalum oxalate (0.5 gram), until a homogeneous solution was obtained. This solution was precipitated, and a hydrous niobate and tantalate was obtained. The potassium was eliminated by leaching the precipitates with acid solution several times, followed by several washing with de-ionized water. The product was characterized and the following results were obtained:
X-Ray Diffraction: Nb₂O₅
Specific surface area, BET analysis method: 10.9 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 750° C. The load was kept at this temperature for 12 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 5.0 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to the reaction temperature of 1450° C. and kept at that level for 8 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.2 m²/g
Tantalum content: 1,510 ppm

The electrical properties were measured, according to the procedure mentioned before. The results were the following:
Capacitance: 99,500 CV/g
Current Leakage: 0.3 nA/CV

The chemical analysis (ppm) of the sample is the following:

C < 30
B < 3
Ca = 16
Cr = 6
Fe < 5
H₂ = 56
Mg = 5
Mn = 6
N₂ < 10
Ni < 10
Ta = 1,510
Zr < 2

### Example 5

500 grams of potassium niobate and 0.6 gram of potassium tantalate were dissolved in water, until a homogeneous solution was obtained. This solution was precipitated, and a hydrous niobate and tantalate was obtained. The potassium was eliminated by leaching the precipitates with acid solution several times, followed by several washing with de-ionized water. The product was characterized and the following results were obtained:
X-Ray Diffraction: Nb₂O₅
Specific surface area, BET analysis method: 9.6 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 700° C. The load was kept at this temperature for 18 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.7 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 8 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.2 m²/g
Tantalum content: 1,570 ppm

The electrical properties were measured, according to the procedure mentioned before. The results were the following:
Capacitance: 85,500 CV/g
Current Leakage: 0.3 nA/CV

The chemical analysis (ppm) of the sample is the following:

C = 43
B < 3
Ca = 9
Cr = 5
Fe < 5
H₂ = 46
Mg = 7
Mn = 6
N₂ = 20
Ni < 10
Ta = 1,570
Zr < 2

### Example 6

300 grams of niobium pentoxide with a suitable pore volume, for instance, 0.30 ml/g, were used as a material to be impregnated by an aqueous solution of either potassium tantalate or potassium heptafluorotantalate. An appropriate amount of potassium tantalate or potassium heptafluorotantalate was weighed to give the desirable tantalum concentration (from 20 ppm to 10 weight percent) was dissolved in 90 ml of water. The solution was then drop-wise added to the niobium pentoxide powder, which in the whole addition process was constantly mixed to allow the total absorption of the impregnation solution into the pores. The moisturized powder was then dried at 120° C. for 24 hours to remove the water from the pores, followed by calcination at 500° C. for 18 hours. The product was characterized and the following results were obtained:
X-Ray Diffraction: Nb₂O₅
Specific surface area, BET analysis method: 13.6 m²/g

A small sample (50 grams) of niobium pentoxide powder impregnated with controlled tantalum content was loaded into a tubular vacuum furnace. Hydrogen gas was admitted into the furnace chamber, and the furnace temperature was raised from room temperature to 700° C. The load was kept at this temperature for 18 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.4 m²/g
Porosity: 79 percent

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1550° C. and kept at that level for 8 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.1 m²/g
Tantalum content: 1,610 ppm
Porosity: 79 per cent

The electrical properties were measured, according to the procedure mentioned before. The results were the following:
Capacitance: 103,600 CV/g
Current Leakage: 0.2 nA/CV

The chemical analysis (ppm) of the sample is the following:

C = 36
B < 3
Ca = 21
Cr = 8
Fe < 5
H₂ = 52
Mg = 8
Mn = 7
N₂ < 10
Ni < 10
Ta = 1,610
Zr < 2

### Example 7

300 grams of niobium pentoxide with a suitable pore volume, for instance, 0.30 ml/g, were used as a material to be impregnated by an aqueous solution of either potassium tantalate or potassium heptafluorotantalate. An appropriate amount of potassium tantalate or potassium heptafluorotantalate was weighed to give the desirable tantalum concentration (from 20 ppm to 10 weight percent) was dissolved in 90 ml of water. The solution was then drop-wise added to the niobium pentoxide powder, which in the whole addition process was constantly mixed to allow the total absorption of the impregnation solution into the pores. The moisturized powder was then dried at 120° C. for 24 hours to remove the water from the pores, followed by calcination at 500° C. for 18 hours. The product was characterized and the following results were obtained:
X-Ray Diffraction: Nb₂O₅
Specific surface area, BET analysis method: 14.5 m²/g

A small sample (50 grams) of niobium pentoxide powder impregnated with controlled tantalum content was loaded into a tubular vacuum furnace. Hydrogen gas was admitted into the furnace chamber, and the furnace temperature was raised from room temperature to 750° C. The load was kept at this temperature for 9 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 5.5 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1550° C. and kept at that level for 8 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.0 m²/g
Tantalum content: 1,480 ppm

The electrical properties were measured, according to the procedure mentioned before. The results were the following:
Capacitance: 115,300 CV/g
Current Leakage: 0.3 nA/CV

The chemical analysis (ppm) of the sample is the following:

C = 39
B < 3
Ca = 23
Cr = 7
Fe < 5
H₂ = 78
Mg = 9
Mn = 8
N₂ < 10
Ni < 10
Ta = 1,480
Zr < 2

### Example 8

360 grams of hydrate niobium pentoxide were mechanically mixed with 0.5 g of tantalum hydrate for several hours at room temperature in a ball mill. The material was calcined at 550° C. for 8 hours. The product was characterized and the following results were obtained:
X-Ray Diffraction: Nb₂O₅
Specific surface area, BET analysis method: 4.6 m²/g

A small sample (50 grams) of niobium pentoxide powder mixed with controlled tantalum content was loaded into a tubular vacuum furnace. Hydrogen gas was admitted into the furnace chamber, and the furnace temperature was raised from room temperature to 700° C. The load was kept at this temperature for 12 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 3.7 m²/g
Porosity: 61 per cent

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 8 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder with controlled tantalum content was separated from the oxygen getter material by sieving using a screen with 0.2 mm mesh size. The product was characterized and the following results were obtained:
X-Ray Diffraction: NbO
Specific surface area, BET analysis method: 1.6 m²/g
Porosity: 60 per cent
Tantalum content: 1,390 ppm

The electrical properties were measured, according to the procedure mentioned before. The results were the following:
Capacitance: 98,400 CV/g
Current Leakage: 0.1 nA/CV

The chemical analysis (ppm) of the sample is the following:

C < 30
B < 3
Ca = 32
Cr = 4
Fe < 5
H₂ = 93
Mg = 7
Mn = 5
N₂ < 10
Ni < 10
Ta = 1,390
Zr < 2

### Example 9

360 grams of hydrate niobium pentoxide were mechanically mixed with 5 g of tantalum hydrate for several hours at room temperature. The material was calcined at 550° C. for 8 hours. The product was characterized and the following results were obtained:
X-Ray Diffraction: Nb₂O₅
Specific surface area, BET analysis method: 4.3 m²/g

A small sample (50 grams) of niobium pentoxide powder mixed with controlled tantalum content was loaded into a tubular vacuum furnace. Hydrogen gas was admitted into the furnace chamber, and the furnace temperature was raised from room temperature to 750°0 C. The load was kept at this temperature for 12 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 2.8 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 10 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder with controlled tantalum content was separated from the oxygen getter material by sieving using a screen with 0.2 mm mesh size. The product was characterized and the following results were obtained:
X-Ray Diffraction: NbO
Specific surface area, BET analysis method: 1.2 m²/g
Tantalum content: 12,850 ppm

The electrical properties were measured, according to the procedure mentioned before. The results were the following:
Capacitance: 95,500 CV/g
Current Leakage: 0.3 nA/CV

The chemical analysis (ppm) of the sample is the following:

C < 30
B < 3
Ca = 27
Cr = 7
Fe < 5
H₂ = 42
Mg = 6
Mn = 6
N₂ < 10
Ni < 10
Ta = 12,850
Zr < 2

### Example 10

400 grams of hydrate niobium pentoxide were mechanically mixed with 55 g of tantalum hydrate for several hours at room temperature. The material was calcined at 550° C. for 8 hours. The product was characterized and the following results were obtained:
X-Ray Diffraction: Nb₂O₅
Specific surface area, BET analysis method: 3.6 m²/g

A small sample (50 grams) of niobium pentoxide powder mixed with controlled tantalum content was loaded into a tubular vacuum furnace. Hydrogen gas was admitted into the furnace chamber, and the furnace temperature was raised from room temperature to 700° C. The load was kept at this temperature for 18 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 3.1 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1550° C. and kept at that level for 8 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder with controlled tantalum content was separated from the oxygen getter material by sieving using a screen with 0.2 mm mesh size. The product was characterized and the following results were obtained:
X-Ray Diffraction: NbO
Specific surface area, BET analysis method: 1.4 m²/g
Tantalum content: 12.1%

The electrical properties were measured, according to the procedure mentioned before. The results were the following:
Capacitance: 85,600 CV/g
Current Leakage: 0.2 nA/CV

The chemical analysis (ppm) of the sample is the following:

C = 41
B < 3
Ca = 31
Cr < 4
Fe < 5
H₂ = 28
Mg = 5
Mn = 9
N₂ < 10
Ni < 10
Zr < 2

The tantalum content was 12.1 weight percent.

### Example 11

360 grams of niobium pentoxide with a pore volume of 0.30 ml/g were used as a material to be impregnated by an aqueous solution of 0.6 g tantalum oxalate. The solution was then drop-wise added to the niobium pentoxide powder, which in the whole addition process was constantly mixed to allow the total absorption of the impregnation solution into the pores. The moisturized powder was then dried at 120° C. for 24 hours to remove the water from the pores, followed by calcination at 500° C. for 18 hours. The product was characterized and the following results were obtained:
X-Ray Diffraction: Nb₂O₅
Specific surface area, BET analysis method: 13.6 m²/g

A small sample (50 grams) of niobium pentoxide powder deposited with controlled tantalum content was loaded into a tubular vacuum furnace. Hydrogen gas was admitted into the furnace chamber, and the furnace temperature was raised from room temperature to 700° C. The load was kept at this temperature for 18 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 3.5 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 10 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder with controlled tantalum content was separated from the oxygen getter material by sieving using a screen with 0.2 mm mesh size. The product was characterized and the following results were obtained:
X-Ray Diffraction: NbO
Specific surface area, BET analysis method: 1.9 m²/g
Tantalum content: 1,650 ppm

The electrical properties were measured, according to the procedure mentioned before. The results were the following:
Capacitance: 75,800 CV/g
Current Leakage: 0.2 nA/CV

The chemical analysis (ppm) of the sample is the following:

C = 35
B < 3
Ca = 14
Cr < 4
Fe < 5
H₂ = 37
Mg = 7
Mn = 8
N₂ < 10
Ni < 10
Ta = 1,650
Zr < 2

### Example 12

1,000 grams of ammonium niobium oxalate were dissolved in a solution containing tantalum oxalate (0.03 g), until a homogeneous solution was obtained. This solution was precipitated, and a hydrate niobium and tantalum oxide was obtained. The precipitates were washed with de-ionized water several times. The precipitates were dried, and calcined to eliminate water and other volatile compounds. The product was characterized and the following results were obtained:
X-Ray Diffraction: Nb₂O₅
Specific surface area, BET analysis method: 10.5 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 700° C. The load was kept at this temperature for 18 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.4 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 8 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.3 m²/g
Tantalum content: 100 ppm

The electrical properties were measured, according to the procedure mentioned before. The results were the following:
Capacitance: 110,800 CV/g
Current Leakage: 0.4 nA/CV

The chemical analysis (ppm) of the sample is the following:

C = 36
B < 3
Ca = 21
Cr = 9
Fe = 12
H₂ = 52
Mg = 4
Mn = 5
N₂ = 10
Ni < 10
Ta = 100
Zr < 2

### Example 13

1,000 grams of ammonium niobium oxalate were dissolved in a solution containing tantalum oxalate (1.51 g), until a homogeneous solution was obtained. This solution was precipitated, and a hydrate niobium and tantalum oxide was obtained. The precipitates were washed with de-ionized water several times. The precipitates were dried, and calcined to eliminate water and other volatile compounds. The product was characterized and the following results were obtained:
X-Ray Diffraction: Nb₂O₅
Specific surface area, BET analysis method: 10.1 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 700° C. The load was kept at this temperature for 9 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.8 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1550° C. and kept at that level for 10 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 1.9 m²/g
Tantalum content: 4,630 ppm

The electrical properties were measured, according to the procedure mentioned before. The results were the following:
Capacitance: 111,700 CV/g
Current Leakage: 0.2 nA/CV

The chemical analysis (ppm) of the sample is the following:

C = 37
B < 3
Ca = 25
Cr = 7
Fe < 5
H₂ = 64
Mg = 5
Mn = 7
N₂ < 10
Ni < 10
Ta = 4,630
Zr < 2

### Example 14

1,000 grams of ammonium niobium oxalate were dissolved in a solution containing tantalum oxalate (2.70 g), until a homogeneous solution was obtained. This solution was precipitated, and a hydrate niobium and tantalum oxide was obtained. The precipitates were washed with de-ionized water several times. The precipitates were dried, and calcined to eliminate water and other volatile compounds. The product was characterized and the following results were obtained:
X-Ray Diffraction: Nb₂O₅
Specific surface area, BET analysis method: 10.0 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 700° C. The load was kept at this temperature for 9 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 7.3 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 8 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.2 m²/g
Tantalum content: 8,250 ppm

The electrical properties were measured, according to the procedure mentioned before. The results were the following:
Capacitance: 100,900 CV/g
Current Leakage: 0.3 nA/CV

The chemical analysis (ppm) of the sample is the following:

C = 36
B < 3
Ca = 32
Cr = 5
Fe = 12
H₂ = 55
Mg = 6
Mn = 5
N₂ = 10
Ni < 10
Ta = 8,250
Zr < 2

### Example 15

1,000 grams of ammonium niobium oxalate were dissolved in a solution containing tantalum oxalate, until a homogeneous solution was obtained. This solution was precipitated, and a hydrate niobium and tantalum oxide was obtained. The precipitates were washed with de-ionized water several times. The precipitates were dried, and calcined to eliminate water and other volatile compounds. The product was characterized and the following results were obtained:
X-Ray Diffraction: Nb₂O₅
Specific surface area, BET analysis method: 9.1 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 750° C. The load was kept at this temperature for 12 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 5.0 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 8 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.3 m²/g
Tantalum content: 11,530 ppm

The electrical properties were measured, according to the procedure mentioned before. The results were the following:
Capacitance: 98,200 CV/g
Current Leakage: 0.3 nA/CV

The chemical analysis (ppm) of the sample is the following:

C = 39
B < 3
Ca = 27
Cr = 12
Fe < 5
H₂ = 46
Mg = 8
Mn = 5
N₂ < 10
Ni < 10
Ta = 11,530
Zr < 2

### Example 16

1,000 grams of ammonium niobium oxalate were dissolved in a solution containing tantalum oxalate, until a homogeneous solution was obtained. This solution was precipitated, and a hydrate niobium and tantalum oxide was obtained. The precipitates were washed with de-ionized water several times. The precipitates were dried, and calcined to eliminate water and other volatile compounds. The product was characterized and the following results were obtained:
X-Ray Diffraction: Nb₂O₅
Specific surface area, BET analysis method: 9.2 m²/g

A small sample (50 grams) of niobium pentoxide with controlled tantalum content was loaded into a tubular vacuum furnace. Hydrogen gas was admitted into the furnace chamber, and the furnace temperature was raised from room temperature to 700° C. The load was kept at this temperature for 18 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 5.4 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 8 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.0 m²/g
Tantalum content: 25,760 ppm

The electrical properties were measured, according to the procedure mentioned before. The results were the following:
Capacitance: 97,400 CV/g
Current Leakage: 0.4 nA/CV

The chemical analysis (ppm) of the sample is the following:

C = 41
B < 3
Ca = 28
Cr = 5
Fe < 5
H₂ = 72
Mg = 5
Mn = 6
N₂ < 10
Ni < 10
Ta = 25,760
Zr < 2

### Example 17

300 grams of niobium pentoxide with a suitable pore volume, for instance, 0.30 ml/g, were used as a material to be impregnated by an aqueous solution of either potassium tantalate or potassium heptafluorotantalate. An appropriate amount of potassium tantalate or potassium heptafluorotantalate was weighed to give the desirable tantalum concentration (from 20 ppm to 10 weight percent) was dissolved in 90 ml of water. The solution was then drop-wise added to the niobium pentoxide powder, which in the whole addition process was constantly mixed to allow the total absorption of the impregnation solution into the pores. The moisturized powder was then dried at 120° C. for 24 hours to remove the water from the pores, followed by calcination at 500° C. for 18 hours. The product was characterized and the following results were obtained:
X-Ray Diffraction: Nb₂O₅
Specific surface area, BET analysis method: 13.8 m²/g

A small sample (50 grams) of niobium pentoxide powder impregnated with controlled tantalum content was loaded into a tubular vacuum furnace. Hydrogen gas was admitted into the furnace chamber, and the furnace temperature was raised from room temperature to 700° C. The load was kept at this temperature for 18 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.9 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1550° C. and kept at that level for 8 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 1.9 m²/g
Tantalum content: 550 ppm

The electrical properties were measured, according to the procedure mentioned before. The results were the following:
Capacitance: 100,200 CV/g
Current Leakage: 0.3 nA/CV

The chemical analysis (ppm) of the sample is the following:

C < 30
B < 3
Ca = 10
Cr = 7
Fe < 5
H₂ = 63
Mg = 7
Mn = 7
N₂ < 10
Ni < 10
Ta = 550
Zr < 2

### Example 18

300 grams of niobium pentoxide with a suitable pore volume, for instance, 0.30 ml/g, were used as a material to be impregnated by an aqueous solution of either potassium tantalate or potassium heptafluorotantalate. An appropriate amount of potassium tantalate or potassium heptafluorotantalate was weighed to give the desirable tantalum concentration (from 20 ppm to 10 weight percent) was dissolved in 90 ml of water. The solution was then drop-wise added to the niobium pentoxide powder, which in the whole addition process was constantly mixed to allow the total absorption of the impregnation solution into the pores. The moisturized powder was then dried at 120° C. for 24 hours to remove the water from the pores, followed by calcination at 500° C. for 18 hours. The product was characterized and the following results were obtained:
X-Ray Diffraction: Nb₂O₅
Specific surface area, BET analysis method: 14.4 m²/g

A small sample (50 grams) of niobium pentoxide powder impregnated with controlled tantalum content was loaded into a tubular vacuum furnace. Hydrogen gas was admitted into the furnace chamber, and the furnace temperature was raised from room temperature to 750° C. The load was kept at this temperature for 18 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.8 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1550° C. and kept at that level for 8 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 1.8 m²/g
Tantalum content: 1,270 ppm

The electrical properties were measured, according to the procedure mentioned before. The results were the following:
Capacitance: 103,100 CV/g
Current Leakage: 0.2 nA/CV

The chemical analysis (ppm) of the sample is the following:

C < 30
B < 3
Ca = 12
Cr = 9
Fe < 5
H₂ = 51
Mg = 6
Mn = 6
N₂ < 10
Ni < 10
Ta = 1,270
Zr < 2

### Example 19

300 grams of niobium pentoxide with a suitable pore volume, for instance, 0.30 ml/g, were used as a material to be impregnated by an aqueous solution of either potassium tantalate or potassium heptafluorotantalate. An appropriate amount of potassium tantalate or potassium heptafluorotantalate was weighed to give the desirable tantalum concentration (from 20 ppm to 10 weight percent) was dissolved in 90 ml of water. The solution was then drop-wise added to the niobium pentoxide powder, which in the whole addition process was constantly mixed to allow the total absorption of the impregnation solution into the pores. The moisturized powder was then dried at 120° C. for 24 hours to remove the water from the pores, followed by calcination at 500° C. for 18 hours. The product was characterized and the following results were obtained:
X-Ray Diffraction: Nb₂O₅
Specific surface area, BET analysis method: 13.1 m²/g

A small sample (50 grams) of niobium pentoxide powder impregnated with controlled tantalum content was loaded into a tubular vacuum furnace. Hydrogen gas was admitted into the furnace chamber, and the furnace temperature was raised from room temperature to 700° C. The load was kept at this temperature for 12 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.5 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 10 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.3 m²/g
Tantalum content: 2,440 ppm

The electrical properties were measured, according to the procedure mentioned before. The results were the following:
Capacitance: 102,200 CV/g
Current Leakage: 0.2 nA/CV

The chemical analysis (ppm) of the sample is the following:

C < 30
B < 3
Ca = 18
Cr = 8
Fe < 5
H₂ = 43
Mg = 5
Mn = 5
N₂ < 10
Ni < 10
Ta = 2,440
Zr < 2

### Example 20

300 grams of niobium pentoxide with a suitable pore volume, for instance, 0.30 ml/g, were used as a material to be impregnated by an aqueous solution of either potassium tantalate or potassium heptafluorotantalate. An appropriate amount of potassium tantalate or potassium heptafluorotantalate was weighed to give the desirable tantalum concentration (from 20 ppm to 10 weight percent) was dissolved in 90 ml of water. The solution was then drop-wise added to the niobium pentoxide powder, which in the whole addition process was constantly mixed to allow the total absorption of the impregnation solution into the pores. The moisturized powder was then dried at 120° C. for 24 hours to remove the water from the pores, followed by calcination at 500° C. for 18 hours. The product was characterized and the following results were obtained:
X-Ray Diffraction: Nb₂O₅
Specific surface area, BET analysis method: 12.7 m²/g

A small sample (50 grams) of niobium pentoxide powder impregnated with controlled tantalum content was loaded into a tubular vacuum furnace. Hydrogen gas was admitted into the furnace chamber, and the furnace temperature was raised from room temperature to 750° C. The load was kept at this temperature for 12 hours, whereupon the heating was turned off. The hydrogen atmosphere was maintained until the load reached room temperature, whereupon the furnace chamber was pressurized with nitrogen prior to removal of the load from the furnace. The product of this first reduction step had the following properties:
X-Ray Diffraction: NbO₂
Specific surface area, BET analysis method: 6.3 m²/g

A small sample (20 grams) of niobium dioxide with controlled tantalum content, produced in the first reducing step, was loaded into a niobium crucible, together with 71 g of powdered niobium hydride with particle size of less than 0.6 mm and more than 0.3 mm. The crucible containing the mixture was loaded into the chamber of an electric vacuum furnace, the furnace chamber was evacuated and thereafter was pressurized with hydrogen gas to a pressure 30 Torr above atmospheric pressure. The temperature was raised from room temperature to a reaction temperature of 1450° C. and kept at that level for 8 hours. After that time, the furnace was turned off and the furnace chamber was evacuated until it was reached a pressure of 5×10⁻⁴ Torr. The furnace chamber was allowed to cool down until room temperature prior to pressurizing the same with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 2.3 m²/g
Tantalum content: 5,410 ppm

The electrical properties were measured, according to the procedure mentioned before. The results were the following:
Capacitance: 97,300 CV/g
Current Leakage: 0.3 nA/CV

The chemical analysis (ppm) of the sample is the following:

C < 30
B < 3
Ca = 14
Cr = 5
Fe < 5
H₂ = 61
Mg = 9
Mn = 6
N₂ < 10
Ni < 10
Ta = 5,410
Zr < 2

### Example 21

1,000 grams of ammonium niobium oxalate were dissolved in a solution containing tantalum oxalate (0.5 gram), until a homogeneous solution was obtained. This solution was precipitated, and a hydrate niobium and tantalum oxide was obtained. The precipitates were washed with de-ionized water several times. The precipitates were dried, and calcined to eliminate water and other volatile compounds. The product was characterized and the following results were obtained:
X-Ray Diffraction: Nb₂O₅
Specific surface area, BET analysis method: 10.0 m²/g

A small sample (30 grams) of niobium pentoxide with controlled tantalum content obtained by co-precipitation was mixed with 110 grams of powdered niobium hydride with particle size of less than 0.6 mm and more than 0.3 mm. This mixture was loaded into a tubular vacuum furnace. The furnace chamber was evacuated and thereafter was pressurized with hydrogen gas to a pressure 30 Torr above atmospheric pressure. The temperature was raised from room temperature to a reaction temperature of 1550° C. and kept at that level for 12 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 1.2 m²/g
Tantalum content: 1,410 ppm

The electrical properties were measured, according to the procedure mentioned before. The results were the following:
Capacitance: 94,500 CV/g
Current Leakage: 0.3 nA/CV

The chemical analysis (ppm) of the sample is the following:

| | |
|---|---|
| C | <30 |
| B | <3 |
| Ca | =21 |
| Cr | =5 |
| Fe | <5 |
| H₂ | =45 |
| Mg | =7 |
| Mn | =4 |
| N₂ | <10 |
| Ni | <10 |
| Ta | =1,410 |
| Zr | <2 |

### Example 22

300 grams of niobium pentoxide with a suitable pore volume, for instance, 0.30 ml/g, were used as a material to be impregnated by an aqueous solution of either potassium tantalate or potassium heptafluorotantalate. An appropriate amount of potassium tantalate or potassium heptafluorotantalate was weighed to give the desirable tantalum concentration (in this case, around 1,200 ppm) was dissolved in 90 ml of water. The solution was then drop-wise added to the niobium pentoxide powder, which in the whole addition process was constantly mixed to allow the total absorption of the impregnation solution into the pores. The moisturized powder was then dried at 120° C. for 24 hours to remove the water from the pores, followed by calcination at 500° C. for 18 hours. The product was characterized and the following results were obtained:
X-Ray Diffraction: Nb₂O₅
Specific surface area, BET analysis method: 13.1 m²/g

A small sample (30 grams) of niobium pentoxide with controlled tantalum content obtained by impregnation was mixed with 110 grams of powdered niobium hydride with particle size of less than 0.6 mm and more than 0.3 mm. This mixture was loaded into a tubular vacuum furnace. The furnace chamber was evacuated and thereafter was pressurized with hydrogen gas to a pressure 30 Torr above atmospheric pressure. The temperature was raised from room temperature to a reaction temperature of 1550° C. and kept at that level for 12 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 1.2 m²/g
Tantalum content: 1,320 ppm

The electrical properties were measured, according to the procedure mentioned before. The results were the following:
Capacitance: 95,400 CV/g
Current Leakage: 0.2 nA/CV

The chemical analysis (ppm) of the sample is the following:

| | |
|---|---|
| C | <30 |
| B | <3 |
| Ca | =19 |
| Cr | =6 |
| Fe | <5 |
| H₂ | =58 |
| Mg | =5 |
| Mn | =8 |
| N₂ | <10 |
| Ni | <10 |
| Ta | =1,320 |
| Zr | <2 |

### Example 23

360 grams of hydrate niobium pentoxide were mechanically mixed with 0.5 g of hydrate tantalum pentoxide for several hours at room temperature in a ball mill. The material was calcined at 550° C. for several hours. The product was characterized and the following results were obtained:
X-Ray Diffraction: Nb₂O₅
Specific surface area, BET analysis method: 4.1 m²/g

A small sample (30 grams) of niobium pentoxide with controlled tantalum content obtained by mixing was blended with 110 grams of powdered niobium hydride with particle size of less than 0.6 mm and more than 0.3 mm. This mixture was loaded into a tubular vacuum furnace. The furnace chamber was evacuated and thereafter was pressurized with hydrogen gas to a pressure 30 Torr above atmospheric pressure. The temperature was raised from room temperature to a reaction temperature of 1550° C. and kept at that level for 12 hours. After that time, the furnace was turned off and the furnace chamber was evacuated until it was reached a pressure of 5×10⁻⁴ Torr. The furnace chamber was allowed to cool down to room temperature prior to be pressurized with nitrogen. After the pressurization, the chamber was opened and the load was discharged from the furnace. The niobium monoxide powder was separated from the oxygen getter material by sieving using a screen with 0.2 mm mesh size. The product was characterized and the following results were obtained:
X-Ray Diffraction: NbO
Specific surface area, BET analysis method: 1.0 m²/g
Tantalum content: 1,240 ppm

The electrical properties were measured, according to the procedure mentioned before. The results were the following:
Capacitance: 91,100 CV/g
Current Leakage: 0.3 nA/CV

The chemical analysis (ppm) of the sample is the following:

| | |
|---|---|
| C | <30 |
| B | <3 |
| Ca | =23 |
| Cr | =6 |
| Fe | <5 |
| H₂ | =53 |
| Mg | =6 |
| Mn | =5 |
| N₂ | <10 |
| Ni | <10 |
| Ta | =1,240 |
| Zr | <2 |

1. A process for the production of niobium monoxide having a controlled tantalum content comprising:
a first step of reacting niobium pentoxide having a controlled tantalum content in a first reducing atmosphere for a first time period and at a first temperature sufficient to produce niobium dioxide having a controlled tantalum content; and
a second step of reacting said niobium dioxide having a controlled tantalum content using a oxygen getter material and in a second reducing atmosphere for a second time period and at a second temperature sufficient to produce said niobium monoxide having a controlled tantalum content.

2. The process of claim 1 further comprising reacting niobium pentoxide and tantalum to produce said niobium pentoxide having a controlled tantalum content.

3. The process of claim 1 further comprising said oxygen getter material selected from a group consisting of refractory or reactive metals, alloys of said refractory or reactive metals, and hydrides of said refractory or reactive metals or said alloys thereof.

4. The process of claim 3 wherein said oxygen getter material further comprises at least one of niobium, tantalum, alloys of niobium, or tantalum, hydrides of niobium, or tantalum, and hydrides of alloys of niobium or tantalum.

5. The process of claim 3 wherein said refractory or reactive metals further comprise at least one of titanium, zirconium, vanadium, magnesium, calcium, lithium, aluminum, silicon, and manganese.

6. The process of claim 1 wherein said first step further comprises:
said first temperature being from about 500° C. to about 1500° C.; and
said first time period being from about 1 hour to about 24 hours.

7. The process of claim 6 wherein said first step further comprises:
said first temperature being from about 700° C. to about 1100° C.; and
said first time period being from about 8 hours to about 18 hours.

8. The process of claim 1 further comprising said first reducing atmosphere containing one of hydrogen, carbon monoxide, and hydrazine.

9. The process of claim 1 further comprising said first reducing atmosphere containing one of hydrogen, carbon monoxide, hydrazine and at least one inert gas.

10. The process of claim 9 wherein said inert gas further comprises at least one of argon, helium, and nitrogen.

11. The process of claim 1 further comprising said first reducing atmosphere at pressure of 50-2000 Torr.

12. The process of 11 further comprising said first reducing atmosphere at pressure of 200-1200 Torr.

13. The process of claim 1 further comprising said second reducing atmosphere containing hydrogen.

14. The process of claim 1 further comprising said second reducing atmosphere containing hydrogen and at least one inert gas.

15. The process of claim 14 wherein said at least one inert gas further comprises at least one of argon, helium, and nitrogen.

16. The process of claim 14 wherein said at least one inert gas further comprises nitrogen, and said nitrogen is mixed with said hydrogen in a manner to enable nitrogen doping of said niobium monoxide with controlled tantalum content.

17. The process of claim 1 wherein said second step further comprises:
said second temperature being from about 1000° C. to about 1700° C.; and
said second time period being from about 15 minutes to about 18 hours.

18. The process of claim 17 wherein said second step further comprises:
said second temperature being from about 1200° C. to about 1600° C.; and
said second time period being from about 3 hours to about 12 hours.

19. The process of claim 1 further comprising said second reducing atmosphere at pressure of 100-2000 Torr.

20. The process of 19 further comprising said first reducing atmosphere at pressure of 500-1500 Torr.

21. The process of claim 2 further comprising additionally reacting at least one of vanadium, zirconium, titanium, hafnium, tungsten, nitrogen, phosphorous, and boron with said niobium pentoxide containing a controlled tantalum content.

22. The process of claim 21 further comprising said addition of at least one of vanadium, zirconium, titanium, hafnium, tungsten, nitrogen, phosphorous, and boron being in an amount of about 20 ppm to about 20 weight percent.

23. The process of claim 22 wherein said amount further comprises about 100 ppm to about 5 weight percent.

24. The process of claim 21 further comprising said at least one of vanadium, zirconium, titanium, hafnium, tungsten, nitrogen, phosphorous, and boron forming a composite oxide with niobium.

25. A process for the production of niobium monoxide having a controlled tantalum content comprising reacting niobium pentoxide having a controlled tantalum content with a oxygen getter material in a reducing atmosphere for a time period and at a temperature sufficient to produce said niobium monoxide having a controlled tantalum content.

26. The process of claim 25 further comprising reacting niobium pentoxide and tantalum to produce said niobium pentoxide having a controlled tantalum content.

27. The process of claim 25 further comprising said oxygen getter material selected from the group consisting of refractory or reactive metals, alloys of said refractory or reactive metals, and hydrides of said refractory or reactive metals or said alloys thereof.

28. The process of claim 27 wherein said oxygen getter material further comprises at least one of niobium, tantalum, alloys of niobium or tantalum, hydrides of niobium or tantalum, and hydrides of alloys of niobium or tantalum.

29. The process of claim 27 wherein said reactive or refractory metals further comprises at least one of titanium, zirconium, vanadium, magnesium, calcium, lithium, aluminum, silicon, and manganese.

30. The process of claim 25 further comprising:
said temperature being from about 800° C. to about 1700° C.; and
said time period being from about 15 minutes to about 24 hours.

31. The process of claim 30 further comprising:
said temperature being from about 1200° C. to about 1600° C.; and
said time period being from about 3 hours to about 12 hours.

32. The process of claim 25 further comprising said reducing atmosphere containing one of hydrogen, carbon monoxide, and hydrazine.

33. The process of claim 25 further comprising said reducing atmosphere containing hydrogen and at least one inert gas.

34. The process of claim 33 wherein said at least one inert gas further comprises at least one of argon, helium, and nitrogen.

35. The process of claim 33 wherein said at least one inert gas further comprises nitrogen, and said nitrogen is mixed with said hydrogen in a manner to enable nitrogen doping of said niobium monoxide with controlled tantalum content.

36. The process of claim 25 further comprising additionally reacting at least one of vanadium, zirconium, titanium, hafnium, tungsten, nitrogen, phosphorous, and boron with said niobium pentoxide with controlled tantalum content.

37. The process of claim 36 further comprising said addition of at least one of vanadium, zirconium, titanium, hafnium, tungsten, nitrogen, phosphorous, and boron being in an amount of about 20 ppm to about 20 weight percent.

38. The process of claim 37 wherein said amount further comprises about 100 ppm to about 5 weight percent.

39. The process of claim 36 further comprising said at least one of vanadium, zirconium, titanium, hafnium, tungsten, nitrogen, phosphorous, and boron forming a composite oxide with niobium.

40. Niobium monoxide having a controlled tantalum content formed according to a process comprising:
a first step of reacting niobium pentoxide having a controlled tantalum content in a first reducing atmosphere for a first time period and at a first temperature sufficient to produce niobium dioxide having a controlled tantalum content; and
a second step of reacting said niobium dioxide having a controlled tantalum content using a oxygen getter material and in a second reducing atmosphere for a second time period and at a second temperature sufficient to produce said niobium monoxide having a controlled tantalum content.

41. The niobium monoxide having a controlled tantalum content of claim 40 wherein said process further comprises reacting niobium pentoxide and tantalum to produce said niobium pentoxide having a controlled tantalum content.

42. The niobium monoxide with controlled tantalum content of claim 40 further comprising said niobium monoxide with controlled tantalum content having one of a residual niobium dioxide content of 5 weight percent or less, and a residual niobium metal content of 5 weight percent or less.

43. The niobium monoxide with controlled tantalum content of claim 40 further comprising said niobium monoxide with controlled tantalum content having a residual niobium dioxide content of 5 weight percent or less, and a residual niobium metal content of 5 weight percent or less.

44. The niobium monoxide with controlled tantalum content of claim 40 further comprising said niobium monoxide with controlled tantalum content having a tantalum content of about 20 ppm to about 50 weight percent.

45. The niobium monoxide with controlled tantalum content of claim 44 further comprising said niobium monoxide with controlled tantalum content having a tantalum content of about 500 ppm to about 10 weight percent.

46. The niobium monoxide with controlled tantalum content of claim 41 further comprising additionally reacting at least one of vanadium, zirconium, titanium, hafnium, tungsten, nitrogen, phosphorous, and boron with said niobium oxide with controlled tantalum content.

47. The niobium monoxide with controlled tantalum content of claim 46 further comprising said addition of at least one of vanadium, zirconium, titanium, hafnium, tungsten, nitrogen, phosphorous, and boron being in an amount of about 20 ppm to about 20 weight percent.

48. The niobium monoxide with controlled tantalum content of claim 47 further comprising said addition of at least one of vanadium, zirconium, titanium, hafnium, tungsten, nitrogen, phosphorous, and boron being in an amount of about 100 ppm to about 5 weight percent.

49. The niobium monoxide with controlled tantalum content of claim 46 further comprising said at least one of vanadium, zirconium, titanium, hafnium, tungsten, nitrogen, phosphorous, and boron forming a composite oxide with niobium.

50. The niobium monoxide with controlled tantalum content of claim 40 further comprising said niobium dioxide with controlled tantalum content having a specific surface area between about 0.4 m²/g and about 30.0 m²/g.

51. The niobium monoxide with controlled tantalum content of claim 50 further comprising said niobium dioxide with controlled tantalum content having a specific surface area between about 0.8 m²/g and about 9.0 m²/g.

52. The niobium monoxide with controlled tantalum content of claim 40 further comprising said niobium dioxide with controlled tantalum content having a micro-porous structure with a porosity of about 51 percent or greater.

53. The niobium monoxide with controlled tantalum content of claim 40 further comprising said niobium monoxide with controlled tantalum content having a specific surface area between about 0.4 m²/g and about 20.0 m²/g.

54. The niobium monoxide with controlled tantalum content of claim 53 further comprising said niobium monoxide with controlled tantalum content having a specific surface between about 0.8 m²/g and about 6.0 m²/g.

55. The niobium monoxide with controlled tantalum content of claim 40 further comprising said niobium monoxide with controlled tantalum content having a micro-porous structure with a porosity of about 51 percent or greater.

56. The niobium monoxide with controlled tantalum content of claim 40 further comprising said niobium monoxide with controlled tantalum content produced in said second step is substantially pure in that X-ray diffraction techniques would detect substantially no residual amounts of said niobium dioxide or metallic niobium.

57. The niobium monoxide with controlled tantalum content of claim 40 further comprising said niobium monoxide with controlled tantalum content produced in said second step has an atomic ratio of niobium to oxygen of between about 1:0.6 and about 1:1.5.

58. The niobium monoxide with controlled tantalum content of claim 57 further comprising said atomic ratio being between about 1:0.7 and about 1:1.1.

59. The niobium monoxide with controlled tantalum content of claim 40 further comprising said niobium monoxide with controlled tantalum content produced in said second step having similar morphology as said niobium dioxide with controlled tantalum content produced in said first step.

60. Niobium monoxide having a controlled tantalum content formed according to a process comprising reacting niobium pentoxide having a controlled tantalum content with a oxygen getter material in a reducing atmosphere for a time period and at a temperature sufficient to produce said niobium monoxide having a controlled tantalum content.

61. The niobium monoxide having a controlled tantalum content of claim 60 wherein said process further comprises reacting niobium pentoxide and tantalum to produce said niobium pentoxide having a controlled tantalum content.

62. The niobium monoxide with controlled tantalum content of claim 60 further comprising said niobium monoxide with controlled tantalum content having one of a residual niobium dioxide content of 5 weight percent or less, and a residual niobium metal content of 5 weight percent or less.

63. The niobium monoxide with controlled tantalum content of claim 60 further comprising said niobium monoxide with controlled tantalum content having a residual niobium dioxide content of 5 weight percent or less, and a residual niobium metal content of 5 weight percent or less.

64. The niobium monoxide with controlled tantalum content of claim 60 further comprising said niobium monoxide with controlled tantalum content having a tantalum content of about 20 ppm to about 50 weight percent.

65. The niobium monoxide with controlled tantalum content of claim 64 further comprising said niobium monoxide with controlled tantalum content having a tantalum content of about 500 ppm to about 10 weight percent.

66. The niobium monoxide with controlled tantalum content of claim 61 further comprising additionally reacting at least one of vanadium, zirconium, titanium, hafnium, tungsten, nitrogen, phosphorous, and boron with said niobium oxide with controlled tantalum content.

67. The niobium monoxide with controlled tantalum content of claim 66 further comprising said addition of at least one of vanadium, zirconium, titanium, hafnium, tungsten, nitrogen, phosphorous, and boron being in an amount of about 20 ppm to about 20 weight percent.

68. The niobium monoxide with controlled tantalum content of claim 67 further comprising said addition of at least one of vanadium, zirconium, titanium, hafnium, tungsten, nitrogen, phosphorous, and boron being in an amount of about 100 ppm to about 5 weight percent.

69. The niobium monoxide with controlled tantalum content of claim 66 further comprising said at least one of vanadium, zirconium, titanium, hafnium, tungsten, nitrogen, phosphorous, and boron forming a composite oxide with niobium.

70. The niobium monoxide with controlled tantalum content of claim 60 further comprising said niobium monoxide with controlled tantalum content having a specific surface area between about 0.4 m²/g and about 20.0 m²/g.

71. The niobium monoxide with controlled tantalum content of claim 70 further comprising said niobium monoxide with controlled tantalum content having a specific surface area between about 0.8 m²/g and about 6.0 m²/g.

72. The niobium monoxide with controlled tantalum content of claim 60 further comprising said niobium monoxide with controlled tantalum content having a micro-porous structure with a porosity of about 51 percent or greater.

73. A capacitor having an anode formed of niobium monoxide having a controlled tantalum content, wherein said niobium monoxide having a controlled tantalum content is formed according to a process comprising:
a first step of reacting niobium pentoxide having a controlled tantalum content in a first reducing atmosphere for a first time period and at a first temperature sufficient to produce niobium dioxide having a controlled tantalum content; and
a second step of reacting said niobium dioxide having a controlled tantalum content using a oxygen getter material and in a second reducing atmosphere for a second time period and at a second temperature sufficient to produce said niobium monoxide having a controlled tantalum content.

74. The capacitor anode of claim 73 further comprising said niobium monoxide with controlled tantalum content having a tantalum content of about 20 ppm to about 50 weight percent.

75. The capacitor anode of claim 74 further comprising said niobium monoxide with controlled tantalum content having a tantalum content of about 500 ppm to about 10 weight percent.

76. The capacitor anode of claim 73 further comprising additionally reacting said niobium monoxide with controlled tantalum content with at least one of vanadium, zirconium, titanium, hafnium, tungsten, nitrogen, phosphorous, and boron.

77. A capacitor of claim 76 further comprising said at least one of vanadium, zirconium, titanium, hafnium, tungsten, nitrogen, phosphorous, and boron being added in an amount of about 20 ppm to about 20 weight percent.

78. A capacitor of claim 77 wherein said amount further comprises about 100 ppm to about 5 weight percent.

79. The capacitor anode of claim 73 further comprising said capacitor having a capacitance from about 50,000 CV/g to about 300,000 CV/g.

80. The capacitor anode of claim 79 further comprising said capacitor having a capacitance from about 65,000 CV/g to about 160,000 CV/g.

81. The capacitor anode of claim 73 further comprising said capacitor having a leakage current leakage of about 1.0 nA/CV or less.

82. A capacitor having an anode formed of niobium monoxide having a controlled tantalum content, wherein said niobium monoxide having a controlled tantalum content is formed according to a process comprising reacting niobium pentoxide having a controlled tantalum content with a oxygen getter material in a reducing atmosphere for a time period and at a temperature sufficient to produce said niobium monoxide having a controlled tantalum content.

83. The capacitor anode of claim 82 further comprising said niobium monoxide with controlled tantalum content having a tantalum content of about 20 ppm to about 50 weight percent.

84. The capacitor anode of claim 83 further comprising said niobium monoxide with controlled tantalum content having a tantalum content of about 500 ppm to about 10 weight percent.

85. The capacitor anode of claim 82 further comprising additionally reacting said niobium monoxide with controlled tantalum content with at least one of vanadium, zirconium, titanium, hafnium, tungsten, nitrogen, phosphorous, and boron.

86. The capacitor anode of claim 85 further comprising said at least one of vanadium, zirconium, titanium, hafnium, tungsten, nitrogen, phosphorous, and boron being added in an amount of about 20 ppm to about 20 weight percent.

87. The capacitor of claim 86 wherein said amount further comprises about 100 ppm to about 5 weight percent.

88. The capacitor anode of claim 82 further comprising said capacitor having a capacitance from about 50,000 CV/g to about 300,000 CV/g.

89. The capacitor anode of claim 88 further comprising said capacitor having a capacitance from about 65,000 CV/g to about 160,000 CV/g.

90. The capacitor anode of claim 82 further comprising said capacitor having a leakage current leakage of about 1.0 nA/CV or less.

91. A co-precipitation process for the production of niobium pentoxide having a controlled tantalum content, said co-precipitation process comprising:
adding a soluble tantalum salt to a solution of niobium salt;
co-precipitating said niobium salt solution with soluble tantalum salt; and
calcining a product of said co-precipitating step to obtain said niobium pentoxide with controlled tantalum content.

92. An impregnation process for the production of niobium pentoxide having a controlled tantalum content, said impregnation process comprising:
wetting niobium pentoxide with a tantalum saturated solution; and
calcining said niobium pentoxide wetted with said tantalum saturated solution to obtain said niobium pentoxide with controlled tantalum content.

93. The impregnation process of claim 92 wherein said niobium pentoxide is hydrate niobium pentoxide.

94. A deposition process for the production of niobium pentoxide having a controlled tantalum content, said deposition process comprising:
covering niobium pentoxide with a tantalum compound; and
calcining said niobium pentoxide covered with said tantalum compound to obtain said niobium pentoxide with controlled tantalum content.

95. The deposition process of claim 94 wherein said tantalum compound is precipitated from a saturated solution.

96. The deposition process of claim 94 wherein said niobium pentoxide is hydrate niobium pentoxide.

97. A mixing process for the production of niobium pentoxide having a controlled tantalum content, said mixing process comprising:
mixing niobium pentoxide with tantalum oxide; and
calcining said niobium pentoxide mixed with said tantalum oxide to obtain said niobium pentoxide with controlled tantalum content.

98. The mixing process of claim 97 wherein said niobium pentoxide is hydrate niobium pentoxide.

99. The mixing process of claim 97 wherein said tantalum oxide is hydrate tantalum oxide.

100. Niobium pentoxide having a controlled tantalum content formed according to a co-precipitation process, wherein said co-precipitation process comprises:
adding a soluble tantalum salt to a solution of niobium salt;
co-precipitating said niobium salt solution with soluble tantalum salt; and
calcining a product of said co-precipitating step to obtain said niobium pentoxide with controlled tantalum content.

101. The niobium pentoxide with controlled tantalum content of claim 100 wherein said niobium pentoxide with controlled tantalum content has a specific surface area from about 1.0 to about 45.0 m²/g.

102. The niobium pentoxide with controlled tantalum content of claim 101 wherein said niobium pentoxide with controlled tantalum content has a specific surface area from about 1.8 to about 20.0 m²/g.

103. The niobium pentoxide with controlled tantalum content of claim 100 wherein said niobium pentoxide with controlled tantalum content has a micro-porous structure with a porosity of about 51 percent or greater.

104. The niobium pentoxide with controlled tantalum content of claim 100 wherein said niobium pentoxide with controlled tantalum content has a sponge-type morphology.

105. The niobium pentoxide with controlled tantalum content of claim 100 wherein said niobium pentoxide with controlled tantalum content has a tantalum content of from about 20 ppm to about 50 weight percent.

106. The niobium pentoxide with controlled tantalum content of claim 105 wherein said niobium pentoxide with controlled tantalum content has a tantalum content of from about 500 ppm to about 10 weight percent.

107. The niobium pentoxide with controlled tantalum content of claim 100 wherein said co-precipitation process further comprises:
adding a soluble salt of at least one of vanadium, zirconium, titanium, hafnium, tungsten, nitrogen, phosphorous, and boron in with said soluble tantalum salt and said niobium salt; and
co-precipitating said at least one of vanadium, zirconium, titanium, hafnium, tungsten, nitrogen, phosphorous, and boron with said niobium salt solution and soluble tantalum salt.
calcining said a product of said co-precipitating step to obtain said niobium pentoxide with controlled tantalum content.

108. The niobium pentoxide with controlled tantalum content of claim 107 further comprising said at least one of vanadium, zirconium, titanium, hafnium, tungsten, nitrogen, phosphorous, and boron being added in an amount of about 20 ppm to about 20 weight percent.

109. The niobium pentoxide with controlled tantalum content of claim 108 wherein said-amount further comprises about 100 ppm to about 5 weight percent.

110. Niobium pentoxide having a controlled tantalum content formed according to an impregnation process, wherein said impregnation process comprises:
wetting niobium pentoxide with a tantalum solution; and
calcining said niobium pentoxide wetted with said tantalum solution to obtain said niobium pentoxide with controlled tantalum content.

111. The niobium pentoxide with controlled tantalum content of claim 110 wherein said niobium pentoxide with controlled tantalum content has a specific surface area from about 1.0 to about 45.0 m²/g.

112. The niobium pentoxide with controlled tantalum content of claim 111 wherein said niobium pentoxide with controlled tantalum content has a specific surface area from about 1.8 to about 20.0 m²/g.

113. The niobium pentoxide with controlled tantalum content of claim 110 wherein said niobium pentoxide with controlled tantalum content has a micro-porous structure with a porosity of about 51 percent or greater.

114. The niobium pentoxide with controlled tantalum content of claim 110 wherein said niobium pentoxide with controlled tantalum content has a sponge-type morphology.

115. The niobium pentoxide with controlled tantalum content of claim 110 wherein said niobium pentoxide with controlled tantalum content has a tantalum content of from about 20 ppm to about 50 weight percent.

116. The niobium pentoxide with controlled tantalum content of claim 115 wherein said niobium pentoxide with controlled tantalum content has a tantalum content of from about 500 ppm to about 10 weight percent.

117. The niobium pentoxide with controlled tantalum content of claim 110 wherein said impregnation process further comprises:
wetting niobium pentoxide with a tantalum saturated solution and a saturated solution of at least one of vanadium, zirconium, titanium, hafnium, tungsten, nitrogen, phosphorous, and boron; and
calcining said niobium pentoxide wetted with said tantalum saturated solution and said saturated solution of at least one of vanadium, zirconium, titanium, hafnium, tungsten, nitrogen, phosphorous, and boron to obtain said niobium pentoxide with controlled tantalum content.

118. The niobium pentoxide with controlled tantalum content of claim 117 further comprising said at least one of vanadium, zirconium, titanium, hafnium, tungsten, nitrogen, phosphorous, and boron being added in an amount of about 20 ppm to about 20 weight percent.

119. The niobium pentoxide with controlled tantalum content of claim 118 wherein said amount further comprises about 100 ppm to about 5 weight percent.

120. Niobium pentoxide having a controlled tantalum content formed according to a deposition process, wherein said deposition process comprises:
covering niobium pentoxide with a tantalum compound; and
calcining said niobium pentoxide covered with said tantalum compound to obtain said niobium pentoxide with controlled tantalum content.

121. The niobium pentoxide with controlled tantalum content of claim 120 wherein said niobium pentoxide with controlled tantalum content has a specific surface area from about 1.0 to about 45.0 m²/g.

122. The niobium pentoxide with controlled tantalum content of claim 121 wherein said niobium pentoxide with controlled tantalum content has a specific surface area from about 1.8 to about 20.0 m²/g.

123. The niobium pentoxide with controlled tantalum content of claim 120 wherein said niobium pentoxide with controlled tantalum content has a micro-porous structure with a porosity of about 51 percent or greater.

124. The niobium pentoxide with controlled tantalum content of claim 120 wherein said niobium pentoxide with controlled tantalum content has a sponge-type morphology.

125. The niobium pentoxide with controlled tantalum content of claim 120 wherein said niobium pentoxide with controlled tantalum content has a tantalum content of from about 20 ppm to about 50 weight percent.

126. The niobium pentoxide with controlled tantalum content of claim 125 wherein said niobium pentoxide with controlled tantalum content has a tantalum content of from about 500 ppm to about 10 weight percent.

127. The niobium pentoxide with controlled tantalum content of claim 120 wherein said deposition process further comprises:
covering niobium pentoxide with a tantalum compound and a compound of at least one of vanadium, zirconium, titanium, hafnium, tungsten, nitrogen, phosphorous, and boron; and
calcining said niobium pentoxide covered with said tantalum compound and said compound of at least one of vanadium, zirconium, titanium, hafnium, tungsten, nitrogen, phosphorous, and boron to obtain said niobium pentoxide with controlled tantalum content.

128. The niobium pentoxide with controlled tantalum content of claim 127 further comprising said at least one of vanadium, zirconium, titanium, hafnium, tungsten, nitrogen, phosphorous, and boron being added in an amount of about 20 ppm to about 20 weight percent.

129. The niobium pentoxide with controlled tantalum content of claim 128 wherein said amount further comprises about 100 ppm to about 5 weight percent.

130. Niobium pentoxide having a controlled tantalum content formed according to a mixing process, wherein said mixing process comprises:
mixing niobium pentoxide with tantalum oxide; and
calcining said niobium pentoxide mixed with said tantalum oxide to obtain said niobium pentoxide with controlled tantalum content.

131. The niobium pentoxide with controlled tantalum content of claim 130 wherein said niobium pentoxide with controlled tantalum content has a specific surface area from about 1.0 to about 45.0 m²/g.

132. The niobium pentoxide with controlled tantalum content of claim 131 wherein said niobium pentoxide with controlled tantalum content has a specific surface area from about 1.8 to about 20.0 m²/g.

133. The niobium pentoxide with controlled tantalum content of claim 130 wherein said niobium pentoxide with controlled tantalum content has a micro-porous structure with a porosity of about 51 percent or greater.

134. The niobium pentoxide with controlled tantalum content of claim 130 wherein said niobium pentoxide with controlled tantalum content has a sponge-type morphology.

135. The niobium pentoxide with controlled tantalum content of claim 130 wherein said niobium pentoxide with controlled tantalum content has a tantalum content of from about 20 ppm to about 50 weight percent.

136. The niobium pentoxide with controlled tantalum content of claim 135 wherein said niobium pentoxide with controlled tantalum content has a tantalum content of from about 500 ppm to about 10 weight percent.

137. The niobium pentoxide with controlled tantalum content of claim 130 wherein said mixing process further comprises:
mixing niobium pentoxide with tantalum oxide and at least one of vanadium, zirconium, titanium, hafnium, tungsten, nitrogen, phosphorous, and boron; and
calcining said niobium pentoxide mixed with said tantalum oxide and said at least one of vanadium, zirconium, titanium, hafnium, tungsten, nitrogen, phosphorous, and boron to obtain said niobium pentoxide with controlled tantalum content.

138. The niobium pentoxide with controlled tantalum content of claim 137 further comprising said at least one of vanadium, zirconium, titanium, hafnium, tungsten, nitrogen, phosphorous, and boron being added in an amount of about 20 ppm to about 20 weight percent.

139. The niobium pentoxide with controlled tantalum content of claim 138 wherein said amount further comprises about 100 ppm to about 5 weight percent.

140. The process of claim 2 wherein said niobium pentoxide having a controlled tantalum content is produced using one of a co-precipitation method, an impregnation method, a deposition method, and a mixing method.

141. The process of claim 26 wherein said niobium pentoxide having a controlled tantalum content is produced using one of a co-precipitation method, an impregnation method, a deposition method, and a mixing method.

142. The capacitor anode of claim 73 wherein said process further comprises reacting niobium pentoxide and tantalum to produce said niobium pentoxide having a controlled tantalum content, which is further reduced to niobium monoxide having a controlled tantalum content.

143. The capacitor anode of claim 82 wherein said process further comprises reacting niobium pentoxide and tantalum to produce said niobium pentoxide having a controlled tantalum content, which is further reduced to niobium monoxide having a controlled tantalum content.
